(19) United States
(12) Patent Application Publication
(10) Pub. No.: US 2006/0290210 A1
(43) Pub. Date: Dec. 28, 2006

(54) Configurable power control system

(75) Inventor: William Williams Foard, Durham, NC (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Foard Geysen, Inc., Durham, NC (US)

(21) Appl. No.: 11/137,625

(22) Filed: May 24, 2005

Related U.S. Application Data
(60) Provisional application No. 60/574,178, filed on May 24, 2004.

(51) Int. Cl. H02G 5/06

(52) U.S. Cl. 307/147

(57) ABSTRACT

Configurable power control systems, devices, and methods are described, along with subsystem components and interconnection approaches. Means are provided for controlling and reconfiguring power outlets and lighting at an intermediate level, with greater control and flexibility than is available in traditionally wired buildings, without the complexity and expense associated with many automation system approaches. These approaches also provide an easily upgradeable path from a relatively simple basic system configuration to a fully automation system configuration.

### CROSS-REFERENCES TO RELATED APPLICATIONS

The present application claims the benefit under 35 U.S.C. 119(e) from U.S. Patent Application No. 60/574,178 filed May 24, 2004 (Attorney Docket No. 019345-000400US), the entire disclosure of which is hereby incorporated by reference for all purposes

### BACKGROUND OF THE INVENTION

This invention generally relates to wiring systems, and in particular provides methods, devices, and systems for delivering power to a load.

The configurable power control system is a new approach to electrical wiring which provides a bridge functionality and intermediate cost point between the traditional, Edison style electrical wiring architecture and full featured automated building control systems. This system provides a means for controlling and reconfiguring power outlets and lighting at an intermediate level, with greater control and flexibility than is available in traditionally wired buildings, without the complexity and expense associated with many automation system approaches. This system also provides an easily upgradeable path from a relatively simple basic system configuration to a fully automation system configuration.

In a traditionally wired building, to implement a switched light or outlet, the high voltage power is wired directly to the switch and from the switch to the load, so the switch turns ON or OFF the lamp or outlet by directly connecting or disconnecting the high voltage to the load.

In fully automated building control systems, a number of strategies are employed to control the power to the load. Many popular systems, such as X10, UPB, and Z-Wave automation systems, are built on the traditional wiring approach, with an added power control layer superimposed on the traditional wiring architecture. This approach has the advantage of working with existing wiring in retrofit situations, but often can be disadvantaged by limiting possibilities to those supported by the underlying wiring approach. Other systems rely on switch and load control wiring home run connected to a central controller, or a control network interconnecting switches and loads via a microprocessor controlled software communications protocol layer.

Many of the building automation approaches tried to date have had difficulty obtaining acceptance beyond a very low percentage fringe element of the building market. These established approaches often provide too little functionality, cost too much, may have reliability and robustness issues, and can be relatively difficult to install, configure and maintain, so have not penetrated the comfort zone of the majority of either the builders or the buyers.

The system approach described herein provides builders and buyers a flexible, easily configurable, robust wiring architecture at a very low base cost, while also providing an affordable post-construction upgrade path to full building automation capabilities.

In a basic system configuration example, the basic implementation level provides individual room or area level control. To obtain logic level power and to support the full automation upgrade path, one master control device in each room is also connected to a main location, either directly or indirectly by connecting through one or more master control devices in other rooms or areas.

Within an individual room or area, at least one master control device, and optionally additional remote or slave devices, control power available at individual power outlets, lights, and/or other wired in appliances through a low voltage control method, with the control devices and signals operating at low voltage and isolated from hazardous power line voltages. The master control device is typically any one of the light switches installed in the room. In a typical room, the line voltage will only be wired to the power outlets and built in lights, while all switch and dimmer control locations will operate at isolated low voltages. Control signals from the switch locations are conveyed to the outlet or wired-in appliance locations via low voltage cabling, and are communicated from the isolated, low voltage exterior of each electrical box to the non-isolated power control device inside the electrical box by an optical interface (in this example implementation).

A simple basic configuration can be implemented with no software, no microprocessors, and very little electronics hardware. This frugal implementation gives the builder and buyer the ability to reconfigure which switches control which outlets or built in lights and appliances, control multiple outlet locations either from a common switch or from separately operating switches, to implement remote switch locations (similar to “3-Way” and “4-Way” switch operation in traditional wiring), and to add additional switches and dimmer controls as desired. This basic configuration costs little to purchase and install, and saves the expense and complexity of planning and installing complex switching arrangements using traditional wiring approaches. Therefore, this approach is suitable for installation in the vast majority of newly constructed homes, as a viable standard alternative to the dated traditional wiring approach. Installing this configuration also provides an infrastructure enabling an easy and incremental up-sell or upgrade path to more features and full automation.

For a very low cost basic pre-install configuration, controllable power devices can to be installed in only those locations that are initially configured as controlled by the installed switches—typically one controllable power device per room or area. The remaining potentially controllable locations can initially have just the wires installed to each outlet location, optionally with the low cost isolated side of the control circuitry installed, with traditional non-controllable receptacles or lights installed in the electrical boxes, and the traditional receptacles can be later easily replaced one at a time with controllable devices when a configuration change is desired.

In the basic configuration example, the switch to outlet assignments are selected by placing shorting jumper plugs on a jumper connector at the master control switch, or possibly by setting switches with equivalent functionality. The jumper plugs connect the switch signal to one or more wires in the room or area's low voltage communication cable, which in turn activates an LED at each selected power control location. The LED shines a light through a hole or window into the electrical box, where a light detector in the non-isolated high voltage power control circuitry activates a power switching device, typically a relay or triac.

Note that each room or area can have a separate low voltage control communication cable, so the rooms are typically not functionally interconnected except via a controller in a full automation upgrade scenario.

A wide variety of device, configuration, and implementation options are possible and practical. Several representative instances of these are shown in the accompanying drawings and discussed in the detailed drawing description section.

This architecture provides an easy and incremental upgrade path to more functionality and full automation. In this example, to provide power to the low voltage isolated circuitry in the system, and to provide a full functionality hard-wired automation system upgrade path, a master control switch device in each room or area is connected to a main location, either directly or indirectly via one or more other master control switch devices. To upgrade to full automation functionality, an automation controller can be connected at the main location to the existing wiring, and the master control switch device replaced with an automation interface master switch device in any room or area where automated functionality is desired.

An alternative implementation example is to locally provide isolated low voltage power to the master control device at each room or area, or to groups of interconnected rooms. Automation interface devices supporting alternative communications methods, such as the RF based Z-Wave protocol, can be installed at the master control device location in each room or area where automation functions are desired, and/or installed directly at any non-switched power device location.

Combinations of automation upgrade approaches can be installed as desired, possibly to take advantage of available strengths and weaknesses inherent in different automation technologies.

### BRIEF SUMMARY OF THE INVENTION

In one aspect, the present invention provides a wiring system that includes a switch control unit comprising a switch in operative association with at least one connector line, an external interface circuit in operative association with the at least one connector line, and a device circuit in operative association with the external interface circuit. The switch can be closed so as to activate the at least one connector line, and the activated connector line can control the device circuit via the external interface circuit. The external interface circuit can include an interface optical signal transmitter for transmitting an interface control signal to the device circuit. The device circuit can be housed within an electrical box, and the interface optical signal transmitter can be configured to transmit the interface control signal from an exterior of the electrical box to the device circuit.

In a related aspect, the wiring system also can include a low voltage optical signal transmitter for transmitting a low voltage control signal to the device circuit. The low voltage optical signal transmitter can be coupled with a low voltage circuit. The low voltage circuit can be housed within an electrically isolated compartment within the electrical box. The device circuit can include a device optical signal transmitter for transmitting an information signal to the interface circuit external to the box or to a low voltage circuit housed within an electrically isolated compartment within the electrical box. The wiring system can include a controlling means for controlling the device circuit to provide a variable power level to an electrical load. In some aspects, the controlling means can include a pulse time referenced to a line voltage zero crossing time.

The external interface circuit can include an interface optical signal transmitter for transmitting an interface control signal to the device circuit, wherein the device circuit is housed within an electrical box, and the interface optical signal transmitter is configured to transmit the interface control signal from an exterior of the electrical box to the device circuit. The wiring system can further include a low voltage optical signal transmitter for transmitting a low voltage control signal to the device circuit, the low voltage optical signal transmitter coupled with a low voltage circuit that is housed within an electrically isolated compartment within the electrical box.

In a second aspect, the present invention provides an optically controlled device circuit disposed for delivering power to an electrical load. The device circuit can include an optical sensor configured to receive an optical signal from at least one of (a) a light source disposed outside of an electrical box, (b) an external optical interface circuit disposed outside of the electrical box, or (c) an internal optical interface device disposed inside of the electrical box in an electrically isolated compartment or module within the box. The optically controlled device circuit can also include a controlling means for controlling the device circuit to provide a variable power level to an electrical load. The controlling means can include a pulse time referenced to a line voltage zero crossing time.

In a third aspect, the present invention provides a method for providing a power level from a device circuit to an electrical load. The method can include transmitting a control signal from to a device circuit. The control signal can originate from an interface control circuit or a low voltage control circuit. The method can also include providing a power level from the device circuit to the electrical load, in response to the control signal. In a related aspect, the method also includes activating at least one connector line of a switch control unit by closing a switch, such that the activated connector line causes the control signal to be transmitted from the interface control circuit or the low voltage control circuit to the device circuit. The method can also include selecting the least one connector line of a switch control unit prior to closing the switch. In a further aspect, the method can include controlling the device circuit to provide a variable power level to the electrical load. Relatedly, the method can include indicating a closed switch by activating an LED.

In another aspect, the present invention provides an addressable wiring system for selecting switch associations with power control devices that switch electrical loads. The electrical loads can include loads connected to electrical outlets, wired-in lighting fixtures, or both. A switch association with one or more power control device(s) can be selected by selecting one or more of multiple control signal wires at the switch location. The power control device can be associated with one of the control signal wires by a direct or indirect connection to one of multiple control wires at or near the power control device location. An optical signal can be used to communicate the control signal from the exterior of an electrical box, or from low voltage circuitry in an electrically isolated compartment within the electrical box, to the line voltage switching circuitry within an electrical box. Relatedly, an optical signal can be used to send information from the circuitry within an electrical box to communication circuitry external to an electrical box, or to low voltage communication circuitry in an electrically isolated compartment within the electrical box.

In a similar aspect, the system can include a control signal bus interconnecting one or more switches and one or more power control devices, or interconnecting one or more switches and optical isolation interface circuitry communicating with one or more power control devices, also carrying communication signals between switch locations, providing a means for multiple switch locations to share the control signal bus. The system can also include a means to control power control devices to provide variable power levels at the electrical loads. In some aspects, a pulse time referenced to the line voltage zero crossing time can be used to control the power to the electrical load. In a related aspect, an optical signal can be used to communicate the control signal from the exterior of an electrical box, or from low voltage circuitry in an electrically isolated compartment within the electrical box, to the line voltage switching circuitry within an electrical box. Similarly, an optical signal can be used to send information from the circuitry within an electrical box to communication circuitry external to an electrical box, or to low voltage communication circuitry in an electrically isolated compartment within the electrical box.

In a further aspect, the system can include a multi-wire control signal bus interconnecting one or more switches and one or more power control devices, or interconnecting one or more switches and optical isolation interface circuitry communicating with one or more power control devices, also carries communication signals between low-voltage sensors and/or devices connected to the control system bus to and/or from the switch circuitry or other control circuitry connected to the control system bus.

In another aspect, the present invention provides an optical interface device for communicating control signals from the exterior of an electrical box to the interior, or from low voltage circuitry in an electrically isolated compartment within the electrical box to the high voltage section of the interior of the electrical box, with control addressing set by control line selection from a multi-wire parallel control signal bus, and a current limiting component in series with the optical transmitter located with the optical interface device. The device can also include an optical signal detection device for receiving communication signals from the interior of an electrical box to the exterior, or from the high voltage section of an electrical box to an electrically isolated compartment within the electrical box, with the received data signal connected to a control bus line shared with other optical interface devices, and a current limiting component in series with the optical detection device. Relatedly, the device can include an additional interface capable of reporting signal levels originating from outside of an electrical box.

In another aspect, the present invention provide an electrical box with features to mount an external optical interface device, with an optically transparent passageway for optical communication signals to pass between the external optical interface device and the interior of the electrical box. In still another aspect, the present invention provides an electrical box with features to mount an internal optical interface device in an electrically isolated compartment or module, with a connector hole for connecting the optical interface device to an external low voltage control signal isolated from the line voltage levels inside the electrical box.

In another aspect, the present invention provides an optically controlled power control device for switching power to a line voltage electrical load, where power is applied to an electrical load in response to an optical sensor circuit illuminated from a light source or optical interface circuit mounted externally on the electrical box, or from an optical interface device in an electrically isolated compartment or module within the electrical box. An optically controlled power control device can also include a variable power level control for switching power to a line voltage electrical load. In some aspects, a power control device can include a variable power level control for switching power to a line voltage electrical load, where the power level to the electrical load is controlled by the timing of the controlling light pulse relative to the line voltage zero crossing time.

In yet another aspect, the present invention provides a power control device that optically sends status information from the power control device to a communications circuit mounted externally on the electrical box, or to an optical interface device in an electrically isolated compartment or module within the electrical box, where the status information is information about the type of the power control device, the state of the power control device, information about one or more connected loads, or any combination of these information types. The power control device can independently control two or more electrical loads. Further, the power control device can use multiple pulses to independently control the electrical loads, with each load independently controlled by a pulse time relative to a reference time.

In another aspect, the present invention provides a switch device for controlling one or more selectable remotely located power control device(s), with the selection of the remotely located power control device(s) controlled by the switch configured by selecting one or more control signal lines from multiple control lines in a control bus, where the power control device is associated with one of the control signal lines by a direct or indirect connection to one of multiple control lines at or near the power control device location. The switch device can control a remotely located power control device by sending a pulse train, with the timing of the pulses in the pulse train referenced to the line voltage zero crossing time. The switch device can also include a means for setting a variable power level at a remotely located power control device, that controls a remotely located power control device by sending a pulse train with the timing of the pulses in the pulse train referenced to the line voltage zero crossing time. Relatedly, the switch device can communicate with a separately located switch device or power level input control device, and can control a remotely located power control device based on input from the separately located switch. The switch device can communicate with an automation system controller, and can control a remotely located power control device based on input from the automation system controller.

In another aspect, the present invention provides a switch device that can communicate with a separately located switch device or power level input control device. The separately located device can be any switch device as described herein. The switch device can be used to cause the separately located device to control a remotely located power control device based on user input.

In still another aspect, the present invention provides a device with an automation system controller communications interface. The device can communicate with a separately located switch device or power level input control device, where the separately located device can be any switch device as described herein. The switch device can cause the separately located device to control a remotely located power control device based on input from the automation system controller.

In another aspect, the present invention provides a device with an automation system controller communications interface. The device can communicate with any optical interface device as described herein. The device can also have an additional interface capable of reporting signal levels originating from outside of an electrical box, and reporting the signal level data originating from outside of an electrical box to the automation system controller.

In another aspect, the present invention provides a device with an automation system controller communications interface. The device can communicate with any power control device as described herein via a control bus and optical interface device, and can report the status information from the power control device to the automation system controller.

For a fuller understanding of the nature and advantages of the present invention, reference should be had to the ensuing detailed description taken in conjunction with the accompanying drawings.

### BRIEF DESCRIPTION OF THE DRAWINGS

FIG. 1 illustrates a bidirectional optical interface circuit according to one embodiment of the present invention.

FIG. 2 illustrates an optically controlled relay circuit according to one embodiment of the present invention.

FIG. 3 illustrates an optically controlled dimmer circuit according to one embodiment of the present invention.

FIG. 4 illustrates a direct optically controlled relay circuit according to one embodiment of the present invention.

FIG. 5 illustrates a direct optically controlled dimmer circuit according to one embodiment of the present invention.

FIG. 6 illustrates a switch control circuit according to one embodiment of the present invention.

FIG. 7 illustrates a multi-switch control circuit according to one embodiment of the present invention.

FIG. 8 illustrates a master/remote/dimmer switch control circuit according to one embodiment of the present invention.

FIG. 9 illustrates a combination optical interface circuit according to one embodiment of the present invention.

FIG. 10 illustrates a combination optically controlled circuit according to one embodiment of the present invention.

FIG. 11 illustrates an automation interface switch control circuit according to one embodiment of the present invention.

FIG. 12 illustrates a switch control circuit with momentary on/off switches according to one embodiment of the present invention.

FIG. 13 illustrates a direct triggered optically controlled dimmer circuit according to one embodiment of the present invention.

FIG. 14 illustrates a direct triggered optically controlled dimmer circuit according to one embodiment of the present invention.

FIG. 15 illustrates a switch control circuit with automatic timer according to one embodiment of the present invention.

FIG. 16 illustrates a directly interfaced optically controlled dimmer circuit according to one embodiment of the present invention.

FIG. 17 illustrates a directly interfaced optically controlled relay circuit according to one embodiment of the present invention.

### DETAILED DESCRIPTION OF THE INVENTION

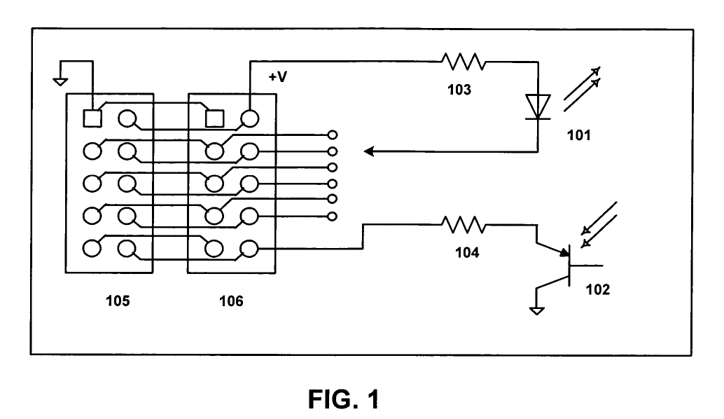

FIG. 1 shows a possible implementation of an optical interface circuit, as might be mounted on the outside of an electrical box. Using this circuit a low voltage circuit, isolated from the power line voltages, can communicate with a non-isolated circuit within the box by shining a light through a small hole or clear plastic window in the electrical box. This implementation supports possible bidirectional communication, with the Light Emitting Diode (LED) 101 being used to send a light signal from outside the box into the box, and a phototransistor 102 or other light sensitive device used to receive a light signal from inside the box and send it to an external isolated low voltage circuit.

In this implementation, two connectors 105 and 106 are shown wired in parallel to simplify external wiring between devices—one can be eliminated with no functional effect. Resistor 103 is used to limit the current to the LED 101. The LED 101 is also connected to one of a set of six pin positions on the connector pair, such that it will respond to a LOW signal on one of six lines, implementing a hardwired address decode at the interface circuit. Interface circuits with up to six unique addresses can be connected together on a parallel wired connecting cable, and more than one interface circuit may be set to a given address.

In this implementation, resistor 104 is used to limit the ‘ON’ state current through the phototransistor 102 when the transistor is illuminated. This current limiting provides a means for other interface circuits on the cable to continue to operate if one interface circuit phototransistor fails in a shorted state, or if a circumstance such as a circuit failure within the electrical box or a missing cover plate leads to a phototransistor being illuminated continuously.

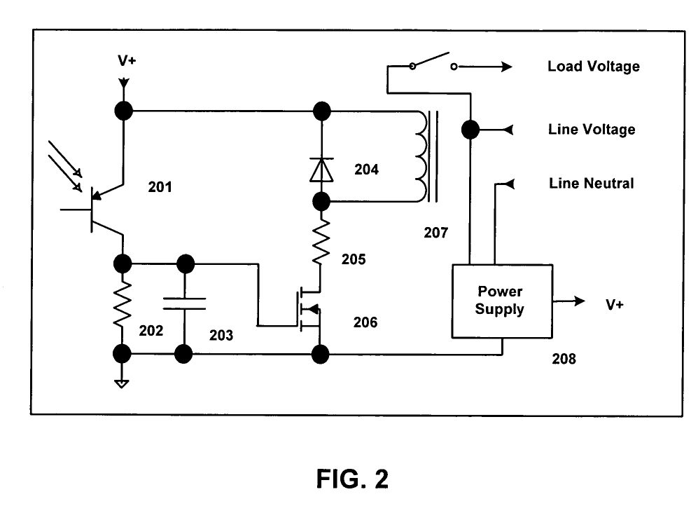

FIG. 2 shows a possible implementation of circuitry that might reside inside an electrical box to communicate with an external isolated interface circuit such as that shown in FIG. 1. Since this circuit is inside the electrical box and optically isolated from any external circuitry, this circuit's power supply 208 does not need to be isolated, and the circuit may use voltages connected to or referenced to the ‘hot’ side of the line power.

In this implementation, a phototransistor 201 detects a light signal, which may be either a continuous level or a pulse, providing a ‘HIGH’ trigger signal on resistor 202 and capacitor 203 relative to the local circuit ground. The capacitor 203 is used to hold the trigger signal in a steady ‘HIGH’ state if the external illumination source is being periodically pulsed. When the trigger signal is ‘HIGH’, the FET 206 becomes conductive, causing a current to flow through the relay coil 207. Resistor 205, if present, limits the current through the relay coil 207, allowing a relay having a specified coil voltage lower than the local supply voltage V+ to be used if desired. The diode 204, placed across the relay coil, is used to dissipate energy stored in the coil when the FET 206 transitions to a non-conductive state, preventing possible damage to the FET 206.

When the relay coil 207 is activated, the relay contacts close, connecting line voltage to any attached load.

In this particular circuit implementation, there is no bidirectional communication. This circuit only receives communications from an isolated interface circuit such as shown in FIG. 1, and does not transmit any information back to the isolated interface circuit.

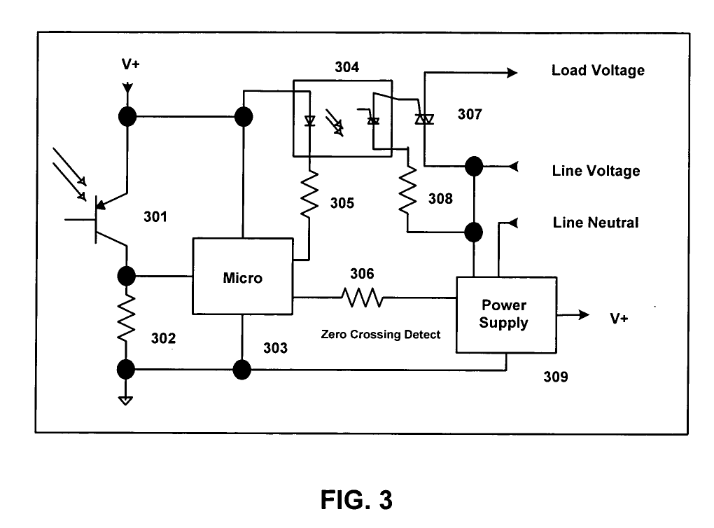

FIG. 3 shows a possible implementation of dimmer or variable power output circuitry that might reside inside an electrical box to communicate with an external isolated interface circuit such as that shown in FIG. 1. Since this circuit is inside the electrical box and optically isolated from any external circuitry, this circuit's power supply 309 does not need to be isolated, and the circuit may use voltages connected to or referenced to the ‘hot’ side of the line power.

In this implementation, a phototransistor 301 detects a light signal, which may be a pulse or pulse sequence, providing a ‘HIGH’ pulse signal on resistor 302 relative to the local circuit ground. The microcontroller 303 interprets the pulsed communication signal, and triggers the optically coupled triac circuit 304 at appropriate times relative to the power line zero crossing time. Resistor 306 provides a current limited zero crossing detection signal from the local power supply to the microcontroller for use as a timing reference. Resistor 305 limits current through the LED input side of the optically isolated triac 304. When the trigger signal to the triac 304 is activated, the output triac side of 304 conducts, sending a trigger to the larger triac 307 to set the triac 307 into a conductive state. Resistor 308 limits the trigger current to the larger triac 307.

When the triac 307 is triggered, it transitions to a conductive state for the remainder of the line voltage half cycle (assuming an appropriate load is attached). The triac 307 trigger time relative to the zero crossing time determines the average power available to the load.

In this particular circuit implementation, there is no bidirectional communication. This circuit only receives communications from an isolated interface circuit such as shown in FIG. 1, and does not transmit any information back to the isolated interface circuit.

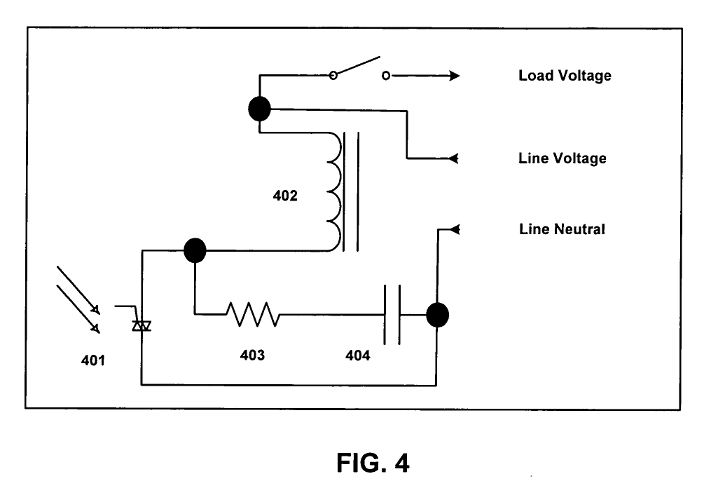

FIG. 4 shows a possible implementation of circuitry to control a relay 402, with similar use as the circuitry show in FIG. 2. In this implementation, an optically triggered triac 401 is used to control the relay directly. This triac 401 is similar to the optically triggered triac 304 shown in FIG. 3, but in this case instead of containing an internal LED trigger light source, the triac 401 is packaged in an optically transparent package and is triggered by the external LED from an isolated interface circuit such as that shown in FIG. 1.

The relay 402 shown in this figure has a line voltage AC coil, rather than a DC low voltage coil as is used by the circuit in FIG. 2. The activation illumination provided to this circuit may be either a continuous illumination, or a pulse train with a pulse shortly after each zero crossing of the line voltage.

The resistor 403 and capacitor 404 connected across the triac form a snubber circuit, as is often implemented in triac circuits controlling inductive loads.

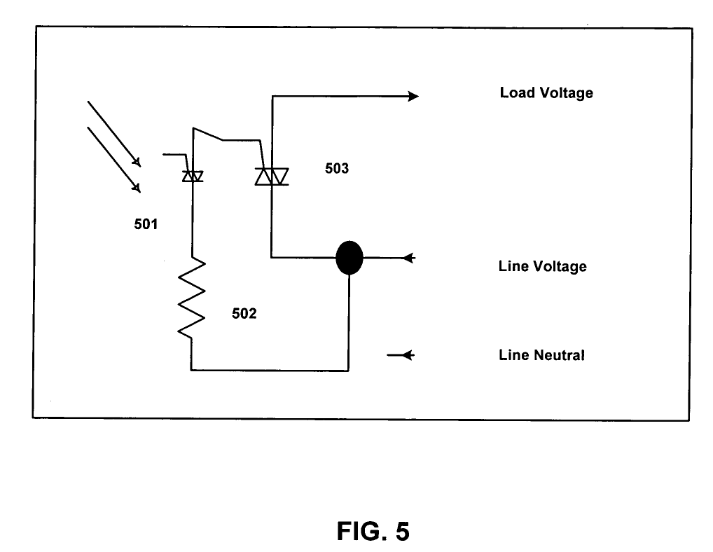

FIG. 5 shows a possible implementation of circuitry to control a triac 503, with similar use as the circuitry show in FIG. 3. In this implementation, an optically triggered triac 501 is used to directly control the trigger to the larger power handling triac 503. The resistor 502 limits the current through the gate of triac 503. This triac 501 is similar to the optically triggered triac 401 shown in FIG. 4, packaged in an optically transparent package and triggered by the external LED from an isolated interface circuit such as that shown in FIG. 1.

The activation illumination provided to this circuit may be either a continuous illumination for full ‘ON’, or a pulse train with a pulse delayed after each zero crossing of the line voltage appropriately to provide the desired average power level to the connected load.

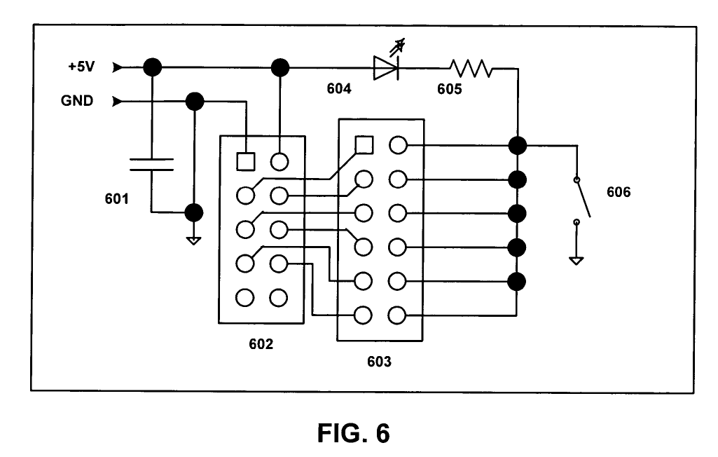

FIG. 6 shows a possible implementation of a switch control circuit. In this circuit implementation, an external supply voltage and ground reference line are provided, with an optional bypass capacitor 601 included as a nicety to help smooth out any transients on the supply voltage. This voltage and ground are passed through connector 602 to externally connected interface circuits such as that shown in FIG. 1, and possibly other circuits such as a remote switch circuit.

Six other pins from connector 602 are connected to jumper connector 603. Shorting blocks placed on connector 603 can connect any or a multiple of the six connector 602 lines to the switched side of the connector 603, which selects external interface circuits such as shown in FIG. 1 to be affected by this switch control circuit.

When switch 606 is closed, current flows through any selected external interface circuits, which can in turn illuminate the external interface circuit communication LED(s), and control a circuit such as the power relay circuit shown in FIG. 2.

The optional LED 604 and current limiting resistor 605 can indicate the ON/OFF state of the switch 606.

This circuit can be intended for use in configurations where it is the only switch control circuit using the selected connector 602 address line attached to a set of external interface circuits.

Note that multiple switch control circuits as shown in FIG. 6, with different connector 602 address lines selected, may be connected together with the connector 602 lines in parallel, with each correctly controlling devices using interface circuits set to their corresponding selected addresses.

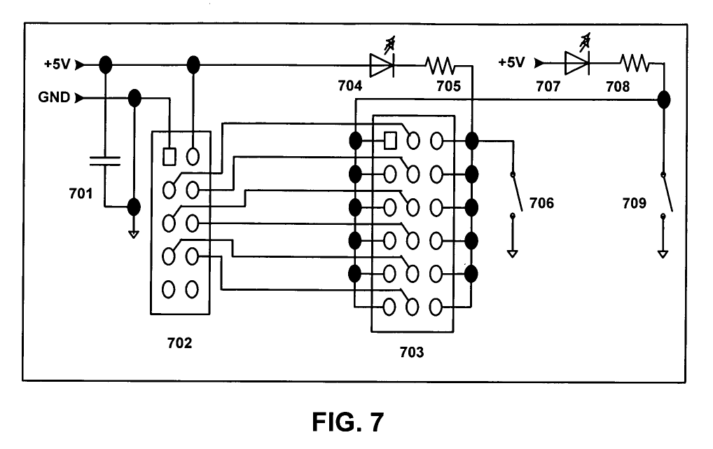

FIG. 7 shows a possible implementation of a multi-switch control circuit, where two or more switches connected to the switch control circuit can independently control different external interface circuits or combinations thereof.

FIG. 7 differs from FIG. 6, for example, by the addition of another row of jumper pins on the jumper connector 703. Similar functionality can alternatively be implemented by adding one or more additional jumper connectors, with the pins connected to the external communications connector 702 wired in parallel. The additional rows of jumper pins is connected to the additional switch 709, with optional LED 707 and current limiting resistor 708 indicating the ON/OFF state of switch 709. Additional jumper connectors, switches, and optional LED switch status indicators can also be added.

Capacitor 701, LED 704, resistor 705, and switch 706 provide similar functionality as the corresponding components in FIG. 6, specifically capacitor 601, LED 604, resistor 605, and switch 606.

This circuit functions similarly to a configuration where multiple FIG. 6 circuits are connected together with connector 602 lines in parallel.

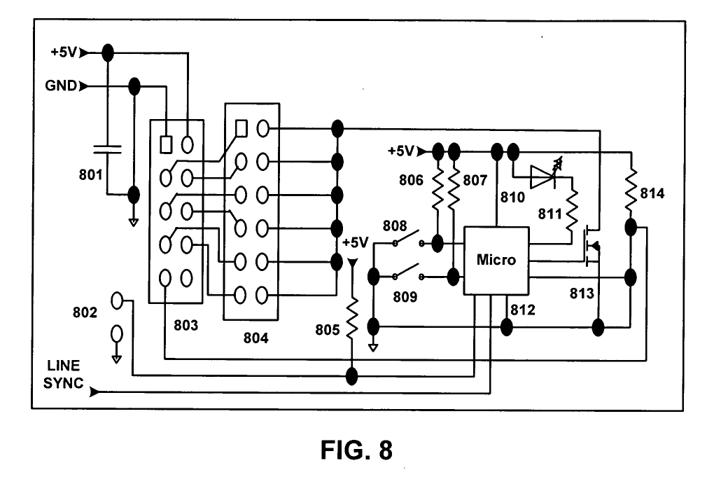

FIG. 8 shows a possible implementation of a switch control circuit that can be used in master switch/remote switch configurations, providing functionality similar to “3-Way” and “4-Way” switch configurations in traditional electrical wiring installations. This switch control circuit implementation also can be used to provide control over dimming capable circuits such as those shown in FIG. 3 and FIG. 5.

In this circuit, which includes capacitor 801, the connector arrangement and use is similar to that shown is FIG. 6, with the addition of a jumper connector 802 and pull-up resistor 805 that can be used to select between dimmer control mode operation and relay control mode operation. The FIG. 6 control switch 606 is replaced in this circuit by a microprocessor controlled FET 813. Also, the optional status LED 810 and current limiting resistor 811 are in this case controlled from the microcontroller 812.

In this example, switch inputs 808 and 809 are connected to pull-up resistors 806 and 807, and to the microprocessor 812. These switch inputs can be used as a push-ON/push-OFF momentary pair if desired, or a static ON/OFF state switch could be used if desired. These switch inputs can be used to control the microprocessor such that the microprocessor sets or toggles the state of the externally controlled devices.

For dimmer operation, switches 808 and 809 can also be used for setting DIM/BRIGHT levels, in addition to providing ON/OFF functionality. This functionality may be implemented by interpreting the length of time the switches are held closed and/or the number of times switches are tapped.

In this example, an output pin on the microprocessor 812 and pull-up resistor 814 are connected to a pin on the external communication connector 803. This output pin is controlled as an open-collector or open-drain output, allowing for bus sharing by multiple microprocessors. The microprocessor can transmit data to other similar circuits on the external communication bus by pulsing the output pin. The same microprocessor 812 output pin also serves as an input pin, or a separate input pin can be connected to the output pin, allowing the microprocessor to receive communications from similar circuits on the bus, so the circuits can have bidirectional half duplex communications using one wire of the external communications cable attached to connector 813.

For master mode operation, the microprocessor controls external interface circuits such as shown in FIG. 1 by switching the FET 813 ON and OFF. Control input can be provided locally through the switch inputs 808 and 809, or from a remote switch or controller via the communication channel pin on connector 803.

For master operation, jumpers on jumper block 804 selects one or more devices to be controlled.

For remote mode operation, all jumper positions on the jumper block 804 are left vacant (signaling to the microprocessor to operate as a remote switch control circuit), or the jumper block 804 can be omitted from the circuit, and the microprocessor typically leaves the FET 813 in a non-conducting state. Control input to the remote microprocessor from switch inputs 808 and 809 are communicated to the master mode switch control circuit by modulating the communications output pin.

In this example implementation, only one master mode switch control circuit is assumed to be configured in the circuit, and for multiple optional remote switch control circuits to be supported.

Note that additional single location switch control circuits with no remote communications support, such as the circuit shown in FIG. 6, may be configured together with this FIG. 8 circuit on the same connector 602/connector 804 bus, with the FIG. 6 and FIG. 8 circuits set to operate on different addresses.

For switch control circuits used in master mode, an externally provided line synch signal can be connected to an input on the microprocessor 812, that can provide a line voltage zero crossing reference signal to the microcontroller to enable transmitting control pulses with positions timed relative to the zero crossing points. For use with relay based controlled device circuits such those shown in FIG. 2 and FIG. 4, the master mode switch controller can control the relay circuit in pulse mode rather than continuous mode to save power use by the isolated side circuitry, and the master can synch the output control pulse signal train to the line synch signal so FIG. 4 type relay circuit implementations provide steady power to the relay. For use with dimmer based controlled device circuits such as the one shown in FIG. 4, the line synch signal is used as a reference point from which to delay the device control pulses to achieve the desired dimmer power level.

Dimmer mode operation can be selected by connecting a shorting block across jumper 802, which is connected to an input pin on the microprocessor 812.

If used with a circuit such as that shown in FIG. 3, the microprocessor 812 can control the FET 813 to transmit pulses to selected interface circuits indicating a dimming level. This communication might be in the form of an encoded bit sequence, or in the form of a pulse position modulated sequence. If used with a circuit such as shown in FIG. 5, the microprocessor can control the FET to transmit a pulse after each zero crossing indication, having a position offset from the zero crossing appropriate to trigger the power control triac to deliver the desired power level to the attached load.

If configured as a dimmer control, and in master mode, the microprocessor 812 can directly control the output pulses through the FET 813. If in remote mode, the switch control circuit can receive its dimmer versus relay mode state from a communications from the master mode circuit, and remotely control the master mode output by sending communications to the master via the communications output pin on the microprocessor 812. The line synch signal does not need to be supplied to the remote switch control circuit.

As shown, two switch inputs are provided, with DIM/BRIGHT control functionality and ON/OFF control functionality combined on the two momentary contact input switches. Other input alternatives and combinations can be provided with a similar circuit but with different microprocessor input and output pin connections. As an example, a rotary encoder might be used for DIM/BRIGHT control, with a push-ON/push-OFF switch to switch the load ON or OFF while keeping the set DIM/BRIGHT level. As another example, a rotary or slider potentiometer can be connected to an Analog to Digital Converter input on the microprocessor to provide DIM/BRIGHT control.

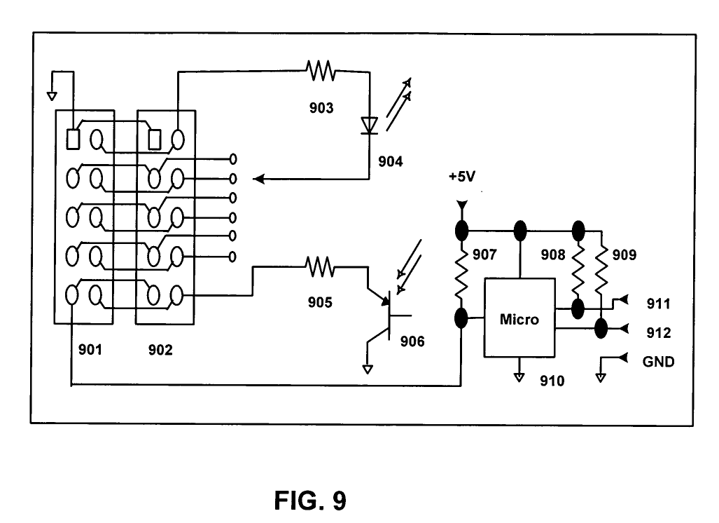

FIG. 9 shows a possible implementation of a combination optical interface circuit, having similar functionality as that implemented in FIG. 1, and also having a microprocessor 910 which shares the bidirectional communication bus used in the master and remote switch control circuit implementation. This implementation includes connectors 901 and 902. As shown in FIG. 9, the microprocessor is used to transmit switch input signals from external switches 911 and 912, which as an example might be connected to reed switches indicating the open/closed state of two windows. As other examples, door switches, under-carpet pressure sensitive switches, motion detector signal outputs, and/or smoke detector relay contact outputs might be connected to the external switch inputs 911 and 912. Resistors 907, 908, and 909 provide pull-up functionality.

The microprocessor might alternatively be used to provide any other functionality or communications interface needed on the low voltage side, isolated from the power line voltages. A similar circuit with isolated interface capability only, not shown, can be implemented by omitting the optical interface components LED 904, Phototransistor 906, and resistors 903 and 905 from the circuit shown in FIG. 9.

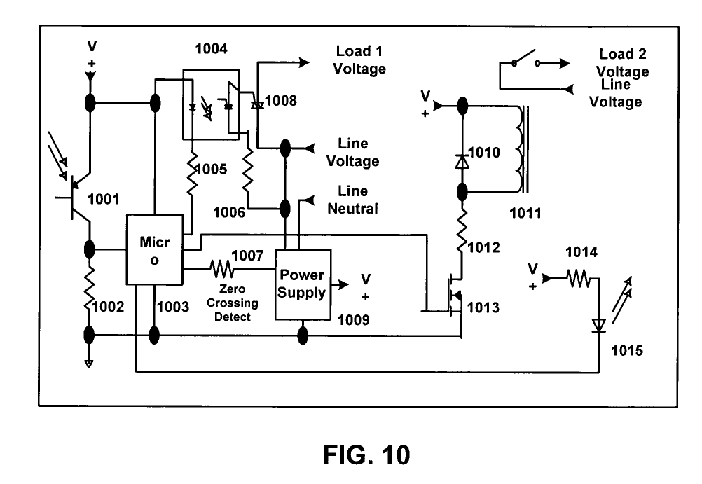

FIG. 10 shows an implementation example combining features similar to those of the circuits shown in FIG. 2 and FIG. 3, and also shows an implementation example with bidirectional communications capability across the optically isolated interface. In this implementation, LED 1015 and current limiting resistor 1014 are controlled by the micro 1003 to illuminate an optical receiver in an isolated interface circuit such as that shown in FIG. 1.

Other components, for example phototransistor 1001, resistor 1002, triac 1004, resistor 1005, resistor 1006, resistor 1007, triac 1008, power supply 1009, diode 1010, relay coil 1011, resistor 1012, and FET 1013, have similar functionality as that described for corresponding components in FIG. 2 and FIG. 3.

As an example, a combination circuit such as the one shown might be used to control multiple associated loads, such as a combination ceiling fan and ceiling light. An example of the use of the communication capability from the non-isolated side to the isolated side is to report back status information about an attached load, such as whether or not a load is locally connected and turned ‘ON’.

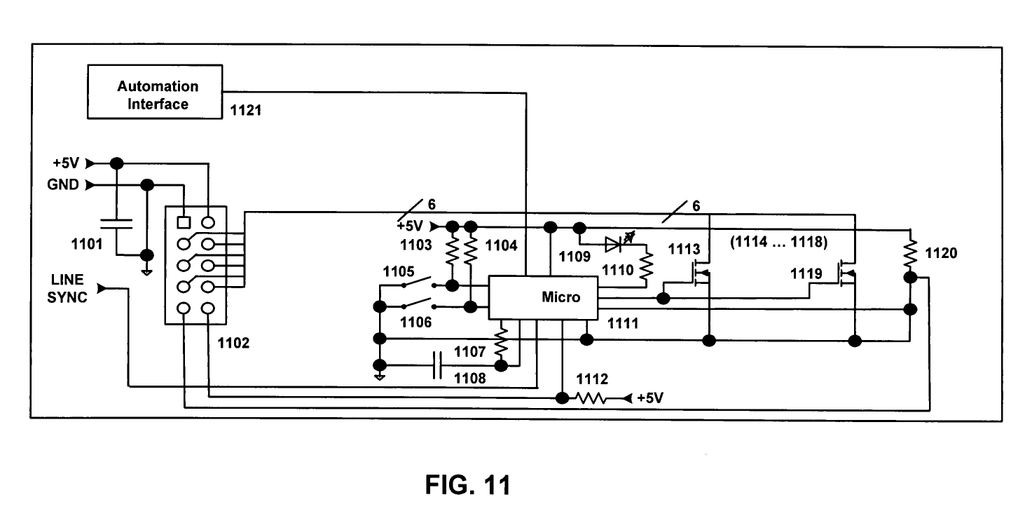

FIG. 11 shows an implementation of a switch control circuit, which also can communicate bidirectionally or unidirectionally with an external controller or other external devices or circuits. This switch control circuit also retains similar capabilities from FIG. 8 to be used as a master, remote, and/or dimming capable switch control circuit.

This circuit is similar to that shown in FIG. 8, with a few changes. First, an automation interface circuit 1121 is added, allowing communications with an external controller or external devices or circuits. This automation interface may conform to one or more standard and/or proprietary interface specifications, such as RS-232, RS-485, X10, and Z-Wave.

Other components, for example capacitor 1101, resistor 1103, resistor 1104, switch inputs 1105 and 1106, diode 1109, resistor 1110, resistor 1112, FET 1113, and resistor 1120 can have similar functionality as that described for FIG. 8.

The implementation shown in FIG. 11 omits the configuration jumper blocks shown in FIG. 8, and adds additional FET output control FETs 1114 through 1119. In this example, the assumption is made that the desired configuration options will be supplied to this circuit via the automation interface, allowing a much wider range of configuration options and greater flexibility including individual control over each of the six control output signal pins.

Note that the six output control lines from the connector 1102 can be bussed together as shown in FIG. 11, in contrast to other embodiment where they are not connected together in this way, as shown in FIGS. 6, 7, and 8.

Also shown on FIG. 11 is a connection from the external bus connector 1102 to the microprocessor 1111 which allows the microprocessor to receive communications from the optically isolated devices, as might be received via the photodetector circuit shown in FIG. 1. In this example, this signal is connected to a comparator input on the microprocessor, with the comparison value software selectable by setting a Pulse Width Modulation (PWM) duty cycle value for the microprocessor output pin connected to the top end of resistor 1107. The capacitor 1108 averages the level from the PWM output, forming a simple Digital to Analog Converter circuit, and the averaged level is supplied as the comparison value for the isolated receive channel comparator. By setting the comparison value level, the circuit can automatically compensate for bias level conditions on the receive channel.

A consequence of the greater flexibility provided by the independent control output FETs 1113 through 1119, and the configuration flexibility possible via the automation interface 1121, is that remote interface circuits may be used to control different output devices. Circuits attached to the bidirectional communications interface pin on the external bus connector 1102, have previously been described as being useful for implementing remote switch operation similar to “3-Way” and “4-Way” traditional switch operation. The remote communications interface can also be used to implement “gang” switch combinations, such as the clusters of co-located switches commonly found in traditional wiring installations. For example, a kitchen and breakfast room switch location might have one switch for the main kitchen light, a dimmer control for a chandelier over a breakfast table, and perhaps switches controlling under-counter lights. This can be implemented with a single automation interface switch control circuit as shown in FIG. 11, with additional remote circuits implemented as shown in FIG. 8, and all the lights controlled through an external interface cable connected to connector 1102. All lights can then be configured and controlled through the automation controller using the single FIG. 11 circuit, behaving as if they were each independently connected to an automation interface circuit.

Another system level feature obtainable from this implementation architecture example is that an automation controller or other external device or circuit can communicate bidirectionally with other isolated and non-isolated devices and circuits attached via the local external control bus connected to connector 1102. As an example, switch inputs from window switch sensors attached to an interface circuit such as is shown in FIG. 9 can be sent to an automation controller or security system master controller. Similarly, as another example, load status information from loads attached to a power control device such as that shown in FIG. 10 can be sent to the automation controller via the automation interface on the FIG. 11 switch control circuit.

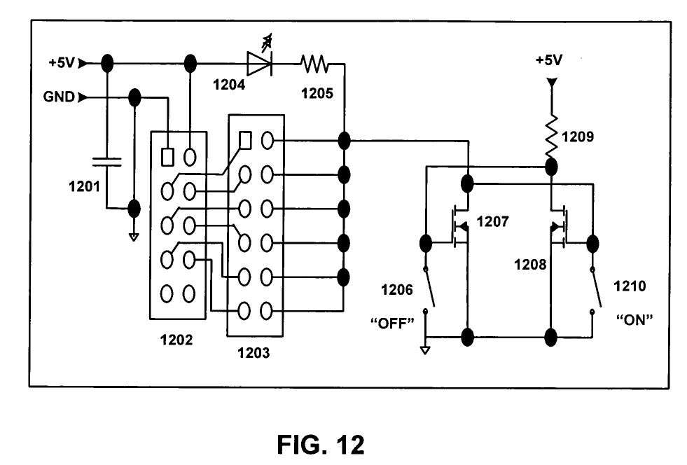

FIG. 12 is similar to the simple switch control circuit in FIG. 6, but shows an implementation using a set-reset flip-flop circuit to control the selected outputs from momentary push button ON/OFF switches. This embodiment includes capacitor 1201 and connectors 1202 and 1203.

In this implementation, the flip-flop is constructed from a pair of FETs, each with its drain wired to the other's gate and with a momentary switch connecting each FET gate to ground when pressed. If the circuit is in the OFF state, FET 1207 is non-conducting, so its drain is pulled HIGH by resistor 1205 and any selected interface modules. This puts a HIGH signal on the gate of FET 1208, causing FET 1208 to conduct and its drain to be pulled to near ground level. This in turn holds the gate of FET 1207 near ground, causing FET 1207 to remain in its non-conducting state.

Momentarily activating the ‘ON’ switch 1210 pulls the gate of FET 1208 to ground, causing FET 1208 to enter a non-conducting state, so its drain is pulled high by resistor 1209. This in turn places a HIGH signal on the gate of FET 1207, causing FET 1207 to conduct and turn ON the optional status LED 1204 and any selected external interface modules. Signal conditions similar but opposite to the ‘OFF’ state conditions described above hold FET 1207 in the ‘ON’ state until the momentary switch 1206 is pressed causing the circuit to revert to the ‘OFF’ state.

Not shown, a multi-switch control circuit similar to FIG. 7 can be also be implemented with additional copies of the dual FET circuit shown here.

Many other similar implementations can be constructed, for example by using a transistor circuit, standard logic component, programmable logic device, or microprocessor to implement the momentary switch latching function.

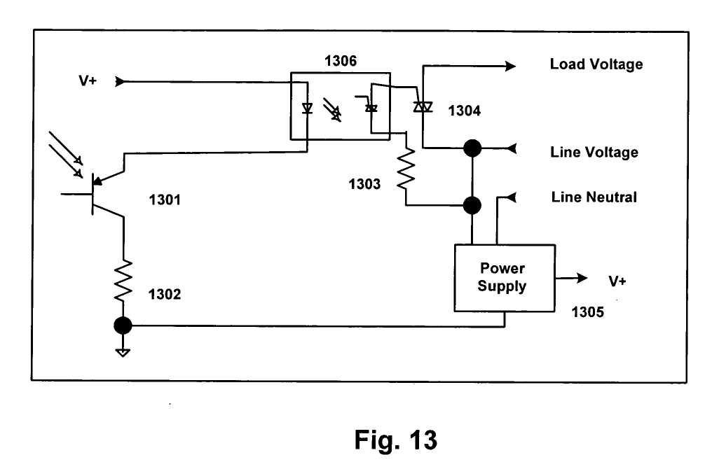

FIG. 13 shows an implementation of an optically controlled dimmer power control circuit, combining implementation features and operational characteristics similar to those shown in FIG. 3 and FIG. 5. In this example circuit, which includes resistor 1303, triac 1304, and triac 1306, the circuit is controlled by an illumination pulse train, with the offset position of the pulse train relative to the zero crossing point of the line voltage determining the average power delivered to the load. From an external control point of view, this circuit operates similar to that in FIG. 5.

However, this circuit may not depend on the availability of an externally triggered optically controlled triac device, as does the circuit shown in FIG. 5. Similar to the microprocessor based circuit of FIG. 3, it also uses a local power supply 1305 and separate phototransistor 1301 to provide a trigger pulse to the closed trigger LED within the isolated triac trigger device 1301.

Alternatively, not shown, the phototransistor 1301 illumination state signal generated across resistor 1302 can be used to turn on a drive FET device connected to the LED portion of the isolated triac trigger device 1301, as is done to drive the relay shown in FIG. 2.

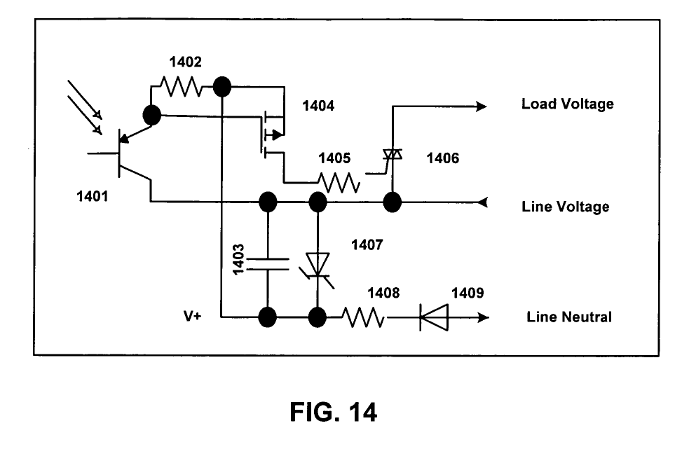

FIG. 14 shows another implementation of an optically controlled dimmer power control circuit. In this example circuit, the circuit is controlled by an illumination pulse train, with the offset position of the pulse train relative to the zero crossing point of the line voltage determining the average power delivered to the load. From an external control point of view, this circuit operates similar to that in FIGS. 5 and 13.

This example implementation uses a local power supply, consisting of a rectifying diode 1409, voltage dropping resistor 1408, Zener diode 1407, and filter capacitor 1403. The power supply generates a positive voltage relative to the Line Voltage side of the supplied line power, to be a convenient trigger power source for a triac 1406 configured to switch the Line Voltage to the load. Therefore, in this circuit no isolation may be needed between the trigger signal and the power triac 1406, differing from the circuit in FIG. 13.

Illuminating the phototransistor 1401 generates a trigger signal across resistor 1402, activating FET 1404 to provide a trigger pulse through the current limiting resistor 1405 to trigger the power isolated triac 1406.

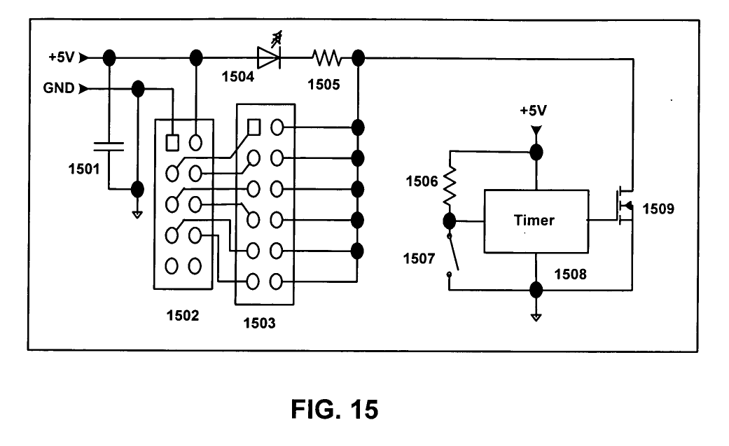

FIG. 15 is similar to the simple switch control circuit in FIG. 6, but shows an implementation using a timer circuit to control the selected outputs from a momentary push button switch. This implementation can include capacitor 1501, connectors 1502 and 1503, diode 1504, and resistor 1505.

In this example, momentary switch 1507 with pull-up resistor 1506 triggers a timer circuit 1508. This timer circuit may be an analog timer implementation such as with an 74121 one-shot timer, NE555 chip, a digital timer implementation, a microprocessor based timer, or possibly a simple capacitor connected ground and to the gate of a second FET with pull-up resistor. The timer output controls the FET 1509, which when conducting activates any selected external devices.

Note that multiple timer switch inputs might be provided in a timer implementation, and possibly multiple timer outputs. As an example, a bathroom fan and/or heat lamp timer might have buttons for a set of different time durations, and be used to control either a fan or heat lamp or both independently.

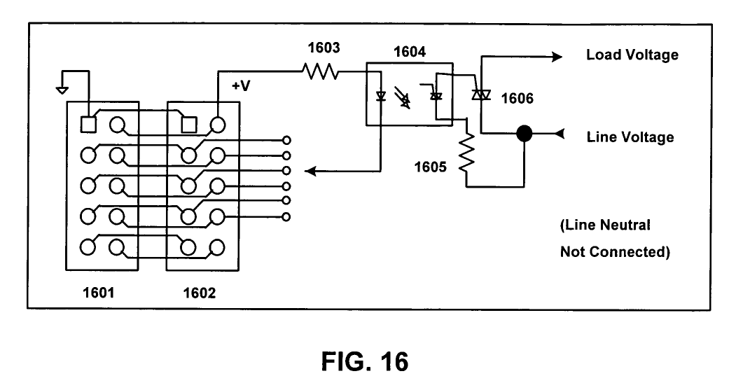

FIG. 16 shows an implementation of an optically controlled dimmer power control circuit, as might be used as a fixture module to control a ceiling light to other permanently wired dimmable load. The circuit shown combines features and operational characteristics similar to those provided in FIG. 1 and FIG. 13, but may not include a separate power supply and second layer of optoisolation.

As a comparison, FIG. 1 provides an implementation where low-voltage control signals can be communicated into an electrical box through exclusively optical means, and the device or circuit inside can be interchanged with another without changing the FIG. 1 interface circuitry. The FIG. 16 circuit might be implemented as a fixture module that is potted and mounted in a knockout hole in the side of an electrical box, so the low voltage connectors are outside of the electrical box, and the high voltage connections are all inside the electrical box, or that low voltage and high voltage wiring are otherwise sufficiently insulated and kept separated within an electrical box.

In this example circuit, the circuit is controlled by a pulse train on the low voltage communication bus on connector 1601, on the control line selected by a jumper on connector 1602, with the offset position of the pulse train relative to the zero crossing point of the line voltage determining the average power delivered to the load.

This circuit may not depend on the availability of an externally triggered optically controlled triac device, as can the circuit shown in FIG. 5.

A signal through the current limiting resistor 1603 and the LED portion of the isolated triac trigger device 1604 turns on the triac drive side of the device 1604, which in turn triggers the larger power driver triac 1606 with gate current limited by resistor 1605. In this case, a resistive load such as an incandescent light is assumed, so no snubber circuit is shown. A similar implementation for use with inductive loads, not shown, can include a resistor and capacitor snubber circuit on the power triac or alternistor 1606, similar to the snubber circuit shown with the relay drive triac in FIG. 4.

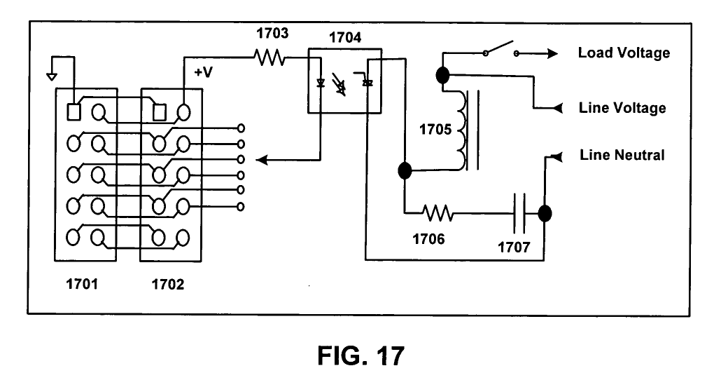

FIG. 17 shows an implementation of an optically controlled relay based power control circuit, similar to the triac based circuit shown in FIG. 16. A circuit similar to this might be used as a fixture module to control a fluorescent light, ceiling fan, or other non-dimmable or unknown load. The circuit shown combines features and operational characteristics from FIG. 4 and FIG. 16.

In this example circuit, the circuit is controlled by a level or pulse train on the low voltage communication bus on connector 1701, on the control line selected by a jumper on connector 1702. If pulse control may be used to minimize drive power, the pulses should be timed to provide essentially continuous power to the relay 1705 when activated.

A signal through the current limiting resistor 1703 and the LED portion of the isolated triac device 1704 turns on the triac drive side of the device 1704, which in turn activates the power relay 1705. Resistor 1706 and 1707 form a snubber network, as shown with the relay drive circuit shown in FIG. 4.

While the exemplary embodiments have been described in some detail, by way of example and for clarity of understanding, those of skill in the art will recognize that a variety of modification, adaptations, and changes may be employed. Hence, the scope of the present invention should be limited solely by the claims.

What is claimed is:

1. A wiring system, the system comprising:
a switch control unit comprising a switch in operative association with at least one connector line;
an external interface circuit in operative association with the at least one connector line; and
a device circuit in operative association with the external interface circuit; wherein the switch can be closed so as to activate the at least one connector line, the activated connector line controlling the device circuit via the external interface circuit.

2. The wiring system of claim 1, wherein the external interface circuit comprises an interface optical signal transmitter for transmitting an interface control signal to the device circuit.

3. The wiring system of claim 2, wherein the device circuit is housed within an electrical box, and the interface optical signal transmitter is configured to transmit the interface control signal from an exterior of the electrical box to the device circuit.

4. The wiring system of claim 3, further comprising a low voltage optical signal transmitter for transmitting a low voltage control signal to the device circuit, the low voltage optical signal transmitter coupled with a low voltage circuit, wherein the low voltage circuit is housed within an electrically isolated compartment within the electrical box.

5. The wiring system of claim 2, wherein the device circuit is housed within an electrical box and comprises a device optical signal transmitter for transmitting an information signal to the interface circuit external to the box or to a low voltage circuit housed within an electrically isolated compartment within the electrical box.

6. The wiring system of claim 1, further comprising a controlling means for controlling the device circuit to provide a variable power level to an electrical load.

7. The wiring system of claim 6, wherein the controlling means comprises a pulse time referenced to a line voltage zero crossing time.

8. The wiring system of claim 6, wherein the external interface circuit comprises an interface optical signal transmitter for transmitting an interface control signal to the device circuit, the device circuit is housed within an electrical box, and the interface optical signal transmitter is configured to transmit the interface control signal from an exterior of the electrical box to the device circuit, the wiring system further comprising a low voltage optical signal transmitter for transmitting a low voltage control signal to the device circuit, the low voltage optical signal transmitter coupled with a low voltage circuit that is housed within an electrically isolated compartment within the electrical box.

9. An optically controlled device circuit disposed for delivering power to an electrical load, the device circuit comprising:
an optical sensor configured to receive an optical signal from at least one of (a) a light source disposed outside of an electrical box, (b) an external optical interface circuit disposed outside of the electrical box, or (c) an internal optical interface device disposed inside of the electrical box in an electrically isolated compartment or module within the box.

10. The optically controlled device circuit of claim 9, further comprising a controlling means for controlling the device circuit to provide a variable power level to an electrical load.

11. The optically controlled device circuit of claim 10, wherein the controlling means comprises a pulse time referenced to a line voltage zero crossing time.

12. A method of providing a power level from a device circuit to an electrical load, the method comprising:
transmitting a control signal from to a device circuit, the control signal originating from an interface control circuit or a low voltage control circuit; and
providing a power level from the device circuit to the electrical load, in response to the control signal.

13. The method of claim 12, further comprising activating at least one connector line of a switch control unit by closing a switch, such that the activated connector line causes the control signal to be transmitted from the interface control circuit or the low voltage control circuit to the device circuit.

14. The method of claim 13, further comprising selecting the least one connector line of a switch control unit prior to closing the switch.

15. The method of claim 14, wherein the device circuit is housed within an electrical box.

16. The method of claim 15, wherein the interface control circuit is disposed outside of the electrical box.

17. The method of claim 14, wherein the interface control circuit or the low voltage control circuit is disposed inside of the electrical box in an electrically isolated compartment or module within the box.

18. The method of claim 12, further comprising controlling the device circuit to provide a variable power level to the electrical load.

19. The method of claim 18, wherein the variable power level is controlled via a pulse time referenced to a line voltage zero crossing time.

20. The method of claim 13, further comprising indicating a closed switch by activating an LED.
